(19) United States
(12) Patent Application Publication
(10) Pub. No.: US 2025/0115086 A1
(43) Pub. Date: Apr. 10, 2025

(54) ADJUSTABLE HITCH ASSEMBLY WITH DRAWBAR, HITCH-BALL MOUNTING BLOCK AND VARIABLE ELEVATION SPACING COLUMN

(71) Applicant: Donald W. Jacobs, Springfield, MO (US)

(72) Inventor: Donald W. Jacobs, Springfield, MO (US)

(21) Appl. No.: 18/910,362

(22) Filed: Oct. 9, 2024

Related U.S. Application Data
(60) Provisional application No. 63/588,799, filed on Oct. 9, 2023.

(51) Int. Cl. B60D 1/46; B60D 1/06

(52) U.S. Cl. CPC B60D 1/46; B60D 1/06

(57) ABSTRACT

An adjustable hitch assembly has a drawbar, a vertically-adjustable hitch-ball mounting block, a variable elevation spacing column, hitch balls, and assorted hardware including a variety pins. The hitch-ball mounting block has essentially an eyebar shape with one eye-end slidable on the column at variable elevation spacings relative the drawbar and the other eye-end receiving the shank base of hitch balls, optionally two inverted with respect to each other. The column has a slide-off prevention provision proximate the bottom end that prevents the hitch-ball mounting block from sliding off the bottom when un-pinned. Thus, the hitch-ball mounting block has to be slid onto the column over the top end thereof at a time before the drawbar. The column is axially striped with one or more axial grooves from top to bottom to reduce sliding friction during vertical re-adjustment of the hitch-ball mounting block.

### CROSS-REFERENCE TO PROVISIONAL APPLICATION(S)

This application claims the benefit of U.S. Provisional Application No. 63/588,799, filed Oct. 9, 2023. The foregoing patent disclosure is incorporated herein by this reference thereto.

### BACKGROUND AND SUMMARY OF THE INVENTION

The invention relates to land vehicles and, more particularly, ball and socket type hitch apparatus.

This application is commonly-invented, commonly-owned with:
U.S. Pat. No. 10,857,846—Jacobs, entitled “Adjustable Hitch Assembly;” and
U.S. Design Pat. No. D1,003,773—Jacobs, entitled “Multivariable Trailer Hitch Assembly.”

The foregoing patent disclosures are incorporated herein by this reference thereto.

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of an adjustable hitch assembly in accordance with the invention which comprises, among other things, three major extruded-aluminum parts, namely a drawbar, a mounting block (for hitch balls) and a variable elevation spacing column;

FIG. 2 is a left side elevation view thereof;

FIG. 3 is a right side elevation view thereof;

FIG. 4 is a rear elevation view thereof;

FIG. 5 is a front elevation view thereof;

FIG. 6 is a top plan view thereof;

FIG. 7 is a bottom plan view thereof;

FIG. 8 is a top plan view of the mounting block and its associated fasteners/hitch balls in isolation from the drawbar and variable elevation spacing column;

FIG. 9 is section view of FIG. 8 taken along a vertical longitudinal bisecting plane through the mounting block and some of its associated fasteners/hitch balls of FIG. 8, ie., wherein removed from view are the clevis pins that secure to the variable elevation spacing column (also not in view);

FIG. 10 is section view in perspective of FIG. 1 taken along a vertical longitudinal bisecting plane through the adjustable hitch assembly of FIG. 1, wherein removed from view are the clevis pins that secure to the variable elevation spacing column;

FIG. 11 is a perspective view comparable to FIG. 1 except exploded, and wherein the clevis pins with their hairpin cotter pins are included;

FIG. 12 is a perspective view of a second embodiment of an adjustable hitch assembly in accordance with the invention, comprising a snap ring (external retaining ring) retention provision along the bottom of the variable elevation spacing column;

FIG. 13 is left side elevation view of FIG. 12;

FIG. 14 is a perspective view of a third embodiment of an adjustable hitch assembly in accordance with the invention, comprising an annular flange retention provision along the bottom of the variable elevation spacing column;

FIG. 15 is a section of FIG. 14 taken along a vertical longitudinal bisecting plane through the adjustable hitch assembly of FIG. 14;

FIG. 16 is a perspective view of a fourth embodiment of an adjustable hitch assembly in accordance with the invention, comprising a dowel pin (or roll pin) retention provision along the bottom of the variable elevation spacing column;

FIG. 17 is left side elevation view of FIG. 16;

FIG. 18 is a perspective view of a fifth embodiment of an adjustable hitch assembly in accordance with the invention, comprising an over-sized washer retention provision along the bottom of the variable elevation spacing column;

FIG. 19 is a section of FIG. 18 taken along a vertical longitudinal bisecting plane through the adjustable hitch assembly of FIG. 18; and

FIG. 20 is a bottom plan view of FIG. 18.

### DETAILED DESCRIPTION OF THE PREFERRED EMBODIMENTS

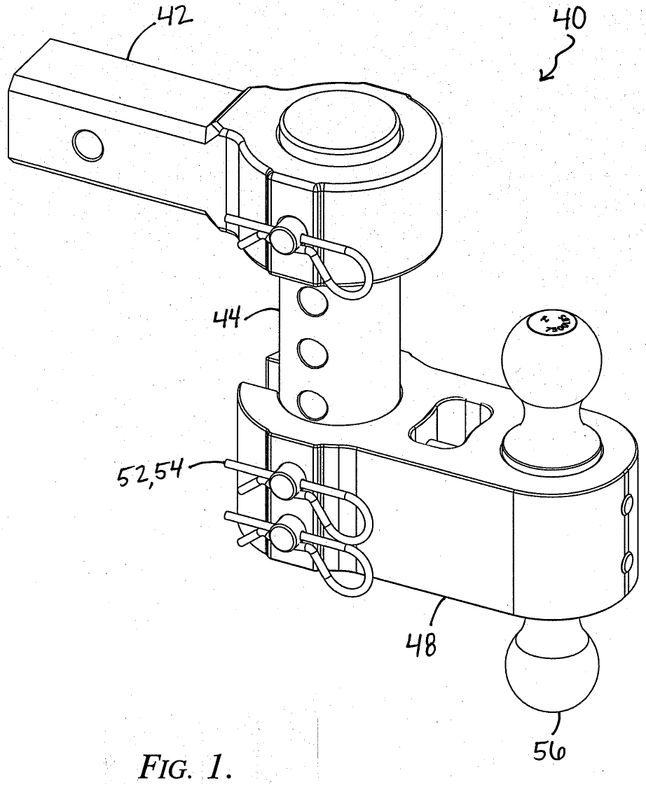

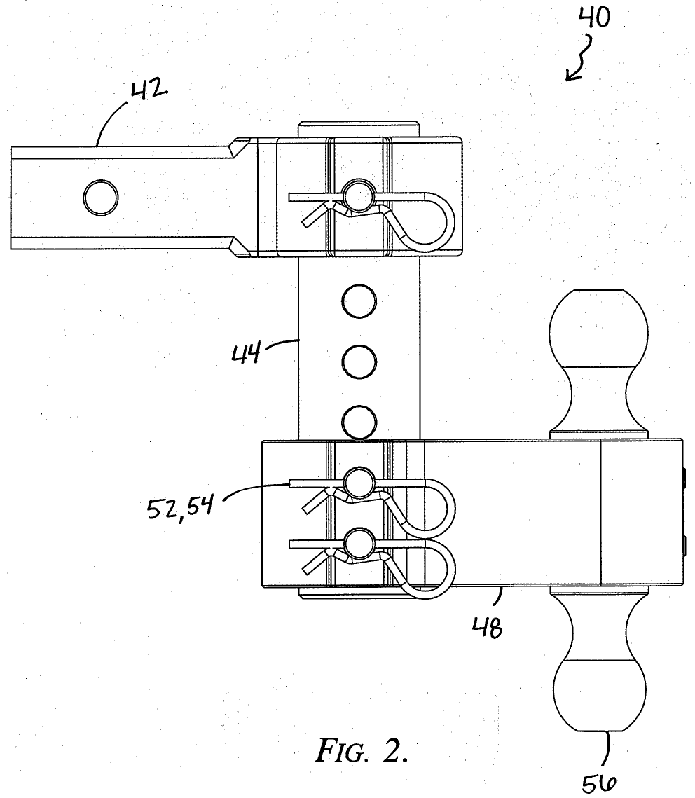

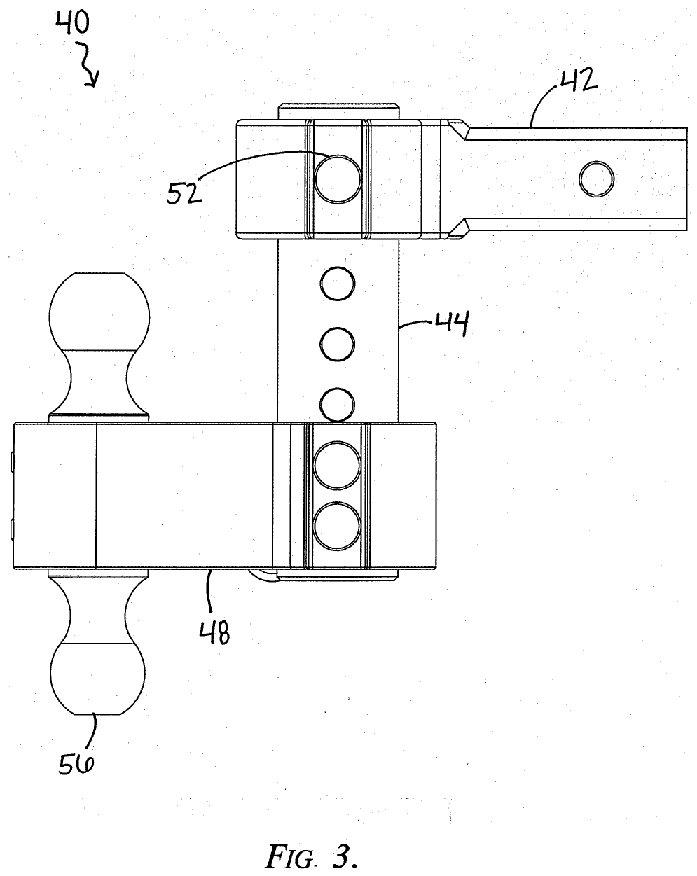

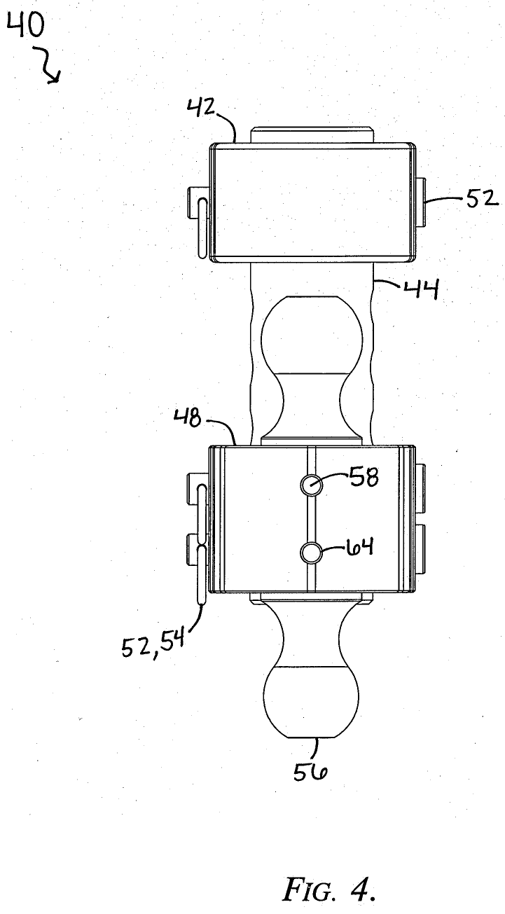

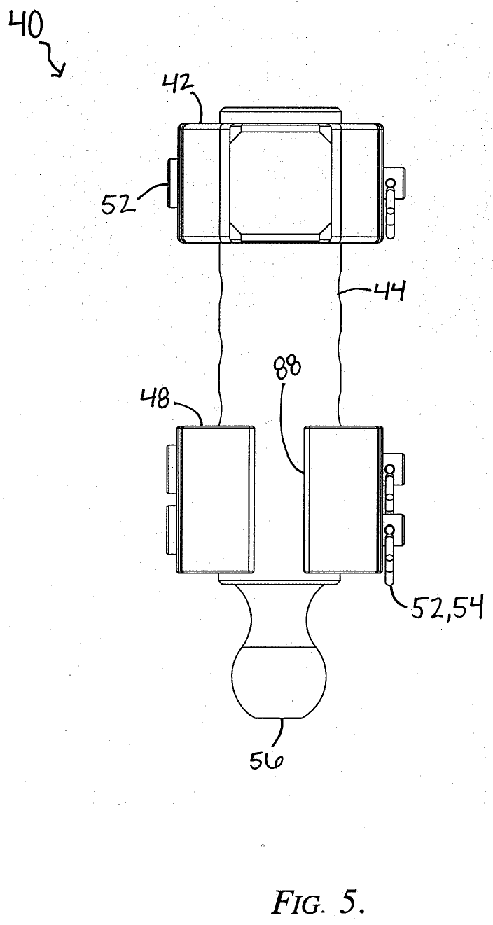

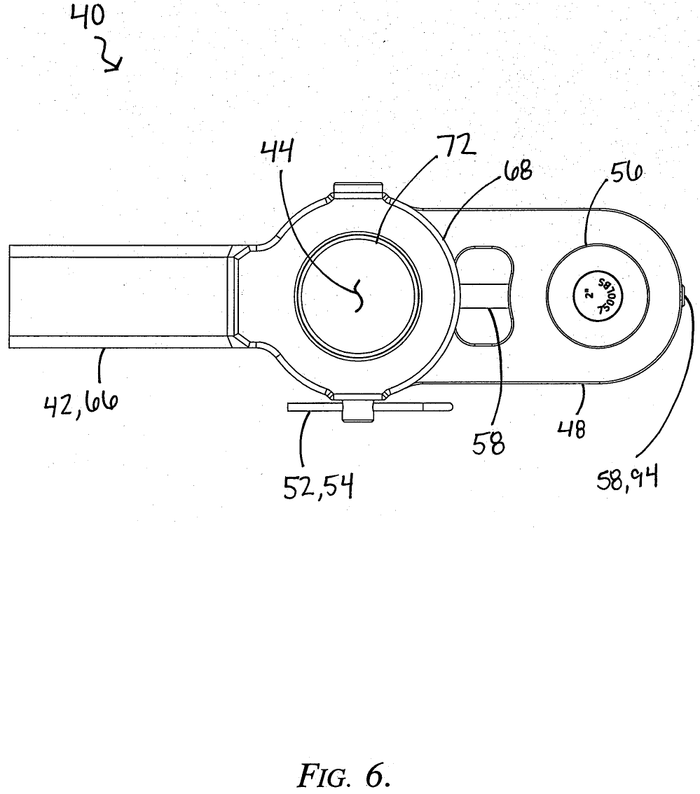

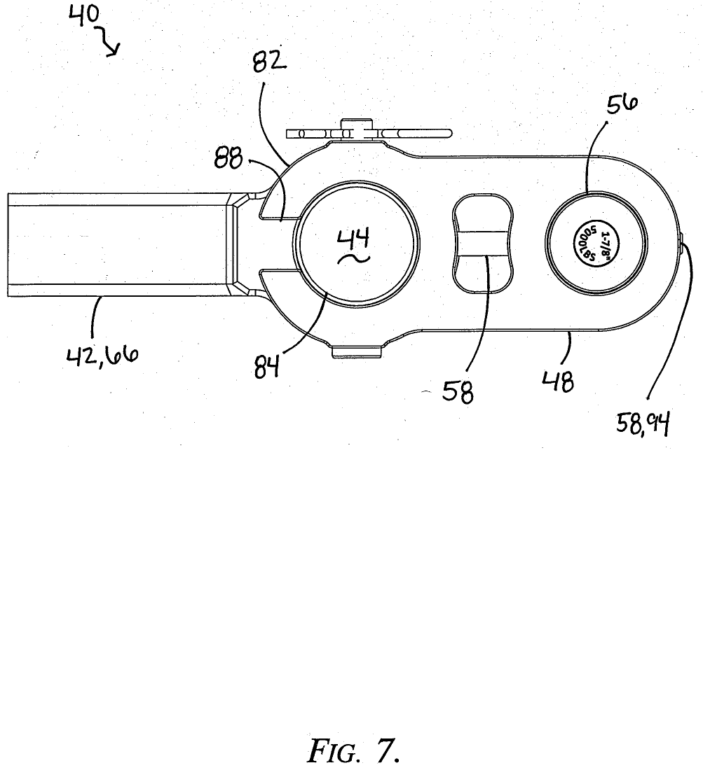

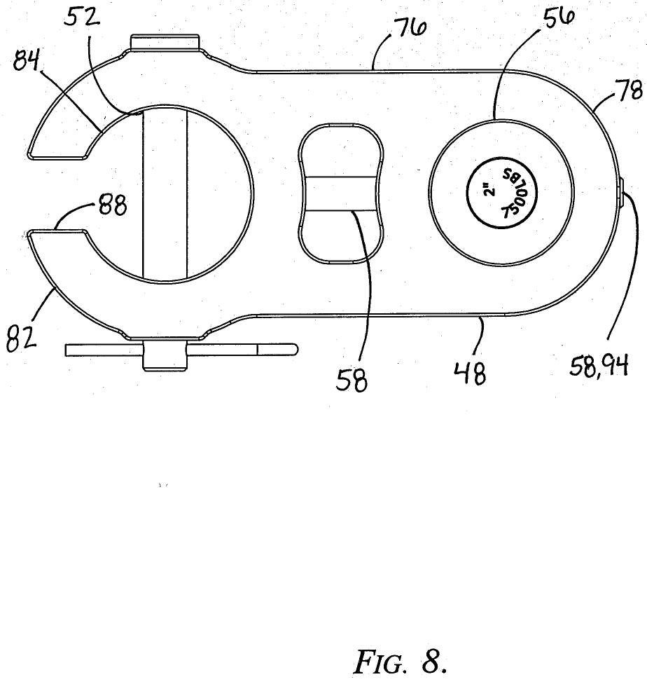

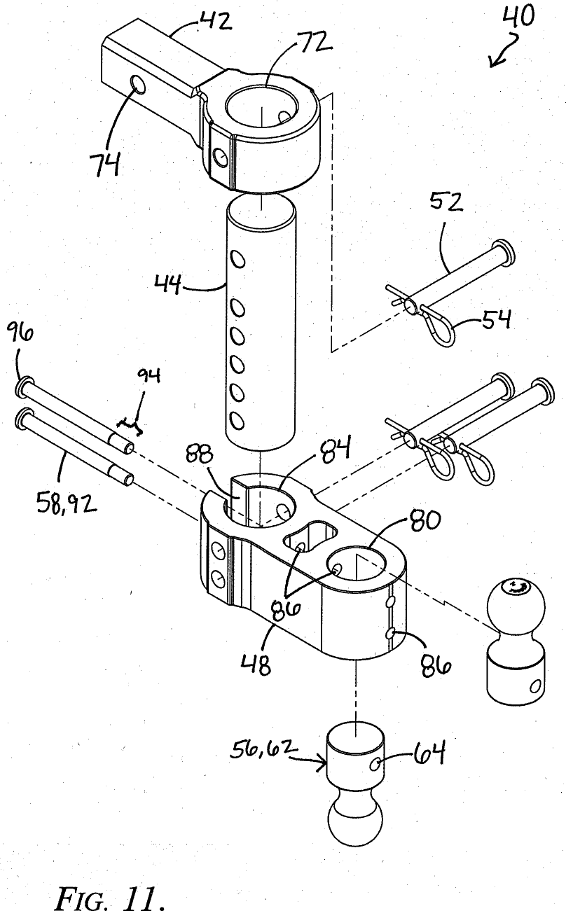

FIGS. 1-11 show a first embodiment of an adjustable trailer hitch assembly 40 in accordance with the invention. A parts list as shown in FIG. 11 comprises the following:
a drawbar 42;
a variable elevation spacing column 44;
a vertically-adjustable hitch-ball mounting block 48;
a set of clevis pins 52 (or hitch pins), with corresponding hairpin cotter pins 54;
at least one, optionally two, hitch balls 56; and
a pair of shoulder pins 58 for securing the hitch balls 56 to the mounting block 48.

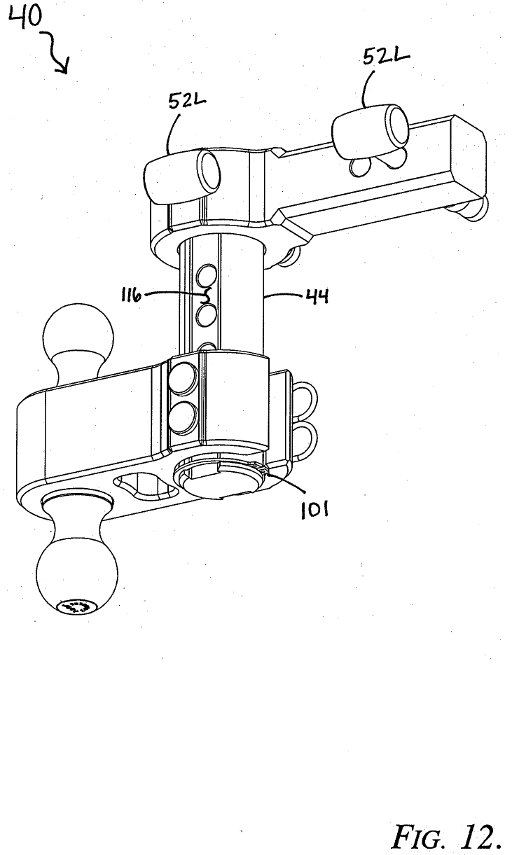

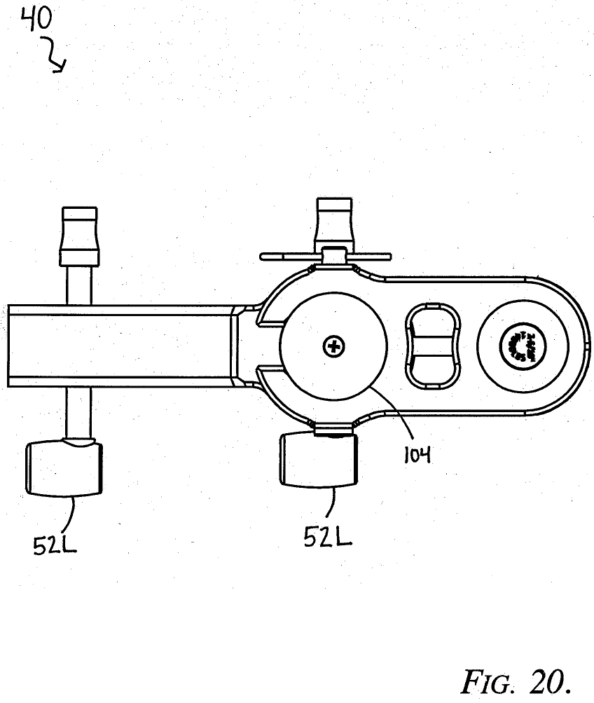

Two of the clevis pins 52 connect the hitch-ball mounting block 48 on the variable elevation spacing column 44 (at the relatively low elevation as shown in FIGS. 1-7 and 10). A third clevis pin 52 connects the drawbar 42 on the variable elevation spacing column 44 (at the relatively high elevation thereon). A fourth pin (eg., see locking hitch pin 52L shown in FIGS. 12, 14, 16, 18 and 20) would connect the drawbar 42 to the square receiver tube (not shown) of the tow vehicle (also not shown).

### Hitch Balls 56.

The preferred hitch balls 56 comprise a ball head and a shank base 62 connected by a neck. The shank base 62 is a solid cylinder and is not threaded, but the solid base does have a through-hole 64 bored through it for receiving a shoulder pin 58.

### Drawbar 42.

The drawbar 42 comprises a generally horizontal drawbar portion 66 having a rectilinear cross-section terminating in an eye-loop portion 68 defining a column-receiving socket 72 for the column 44 to insert therein. The drawbar portion 66 would insert into the square receiver tube (not shown) of the tow vehicle (not shown). The drawbar portion 66 would be bored through with one or more clevis- or hitch-pin receiving holes 74.

### Hitch-Ball Mounting Block 48.

The vertically-adjustable hitch-ball mounting block 48 comprises is a form of an eyebar. That is, it comprises a central bar portion 76 extending between a hitch-ball eye-loop end 82 formed with a hitch-ball shank-receiving socket 80 for a hitch-ball shank 62 to insert therein, and, a column-receiving eye-loop end 82 defining a column-receiving aperture 84 for the column 44 to slide therein.

Both the bar portion 76 and the column-receiving eye-loop end 82 of the vertically-adjustable hitch-ball mounting block 48 are formed with a pair of vertically-spaced pin-receiving holes 86 into the column-receiving aperture 84 that is adapted for a shoulder pin 58 to secure a hitch ball 56 (ie., a hitch-ball pin 58, which is in contrast to a clevis- or hitch-pin 52). The column-receiving eye-loop end 82 of the vertically-adjustable hitch-ball mounting block 48 is formed with an access opening 88 for the flight path of the shoulder pin 58 into the shoulder-pin receiving hole 86 in the shank bases 62 of the hitch balls 56. The access opening 88 preferably comprises a vertical gap or slot.

### Shoulder Pins 58 (Ie., Hitch-Ball Pins 58).

Each shoulder pin 58 comprises a slender cylindrical shank 92 extending between a tip end 94 and an enlarged coin-shaped head 96. An abbreviated portion 94 of the shank 92 proximate the tip end 94 is turned down to have a lesser outside diameter than the rest of the shank 92, hence making this a “shoulder” pin 58. The shoulder-pin receiving hole 86 through the bar portion 76 of the vertically-adjustable hitch-ball mounting block 48 for the shoulder pin 58 defines an entrance 98 in the bar portion 76. The bar portion 76 is counter-sunk at that the entrance 98 of the shoulder-pin receiving hole 86 with a shallow cylindrical counter-bore 98 for receiving the enlarged coin-shaped head 96 of the shoulder pin 58 to nest flush therein. That way, when the column 44 occupies the column-receiving aperture 84 in the vertically-adjustable hitch-ball mounting block 48, the column 44 impedes removal of the shoulder pin 58. On the other hand, the enlarged coin-shaped head 96 of the shoulder pin 58, nesting in the counter-bore 98 for it at the entrance 98 of the hole 86, will not impede the vertical adjustability of the vertically-adjustable hitch-ball mounting block 48 on the column 44.

The shank 92 of the each shoulder pin 58 is smooth. The shoulder pin 58 is inserted by sliding, not twisting as with a threaded fastener.

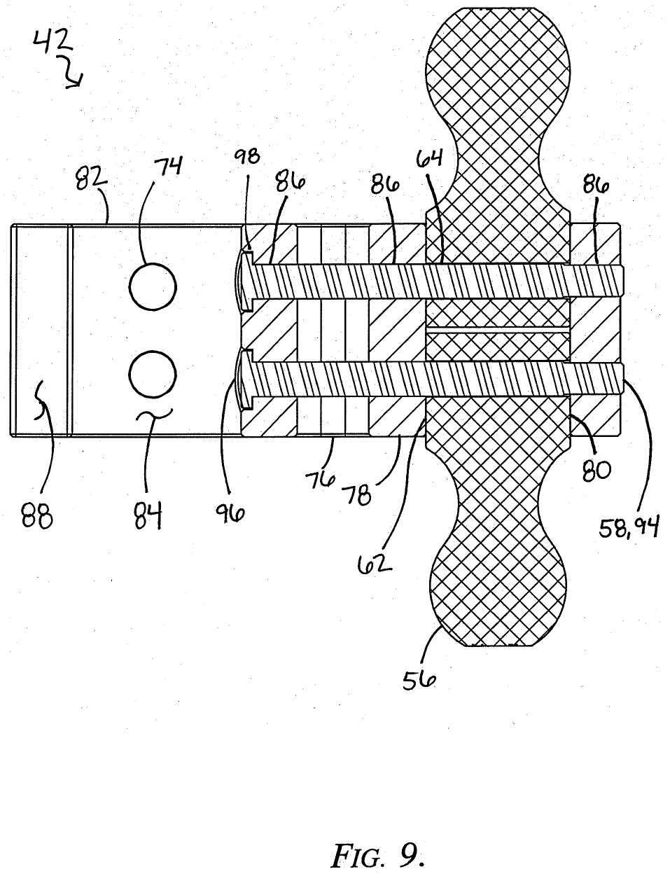

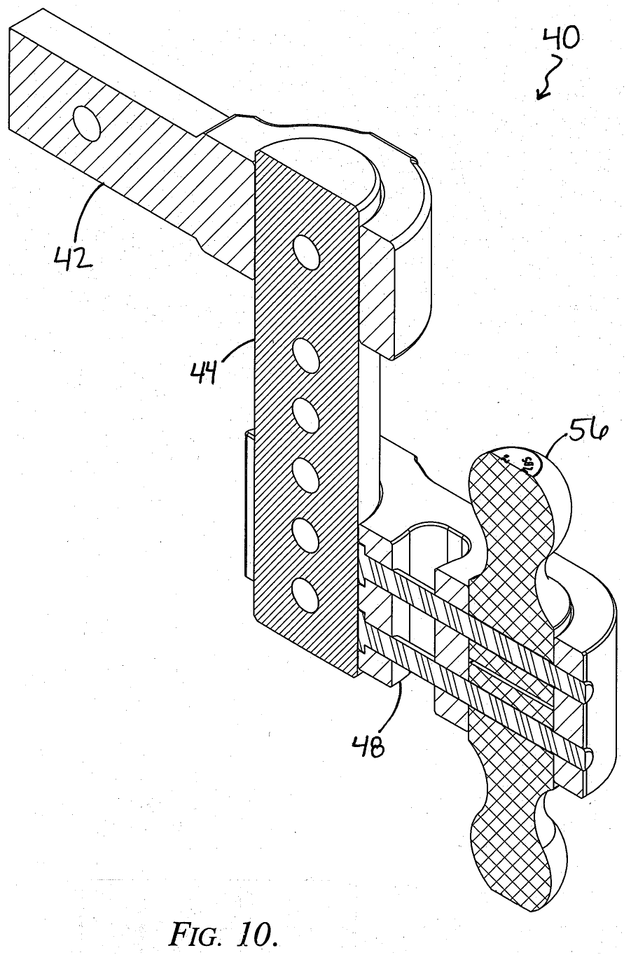

The column-receiving eye-loop end 82 of the vertically-adjustable hitch-ball mounting block 48 is formed all the way through with the shoulder-pin receiving hole 86 as a through-hole from the entrance in the bar portion 76 to an exit in a far wall of the column-receiving eye-loop end 82. The shoulder pin 58 is sized such with the head 96 of the shoulder pin 58 nested in the shallow counter-bore 98 for it at the entrance 98 of the hole 86, the tip end 94 is proximate, preferably perfectly flush, with the exit of hole 86 in the far wall of the column-receiving eye-loop end 82. However, at the far wall of the column-receiving eye-loop end 82, the hole 86 is of a reduced diameter because the tip end 94 of the shoulder pin 58 is likewise of reduced diameter. FIGS. 9 and 10 show better how the shoulder pins 58 connect the hitch balls 56 to the hitch-ball mounting block 48.

The preferred geometry for the column 44, the column-receiving aperture 84 in the vertically-adjustable hitch-ball mounting block 48, and the column-receiving socket 72 in the eye-loop portion 68 of the drawbar 42 is, namely cylindrical.

Preferably, the vertically-adjustable hitch-ball mounting block 48 is produced from slices of extruded aluminum stock, and this results in the hitch-ball shank-receiving socket 80 being a through aperture. That way, two hitch-ball pins 58 can be releasably connected the mounting block 48 relatively inverted relative to each other. The drawbar 42 is likewise preferably produced from slices of extruded aluminum stock and this also results in the column-receiving socket 72 being a through aperture.

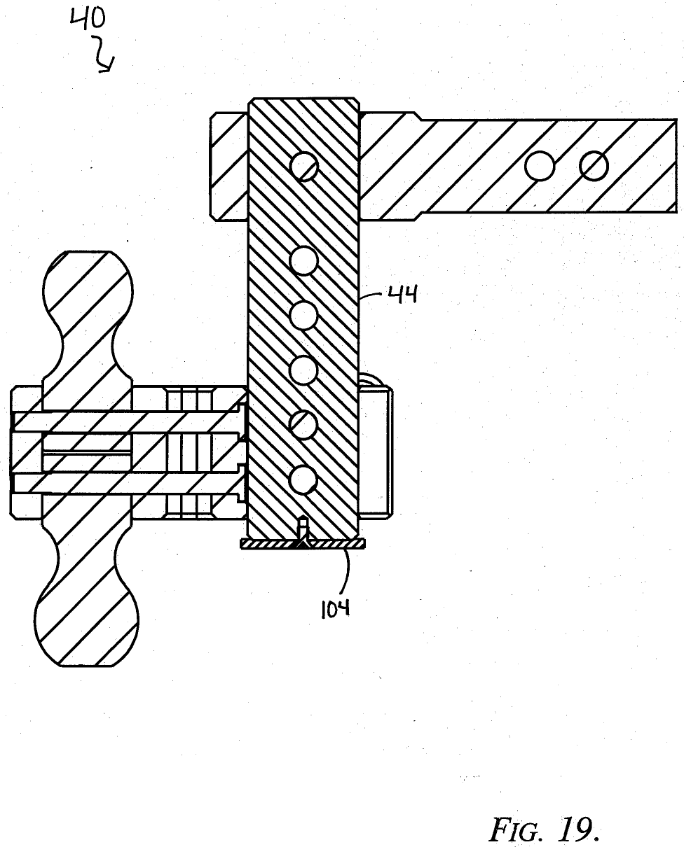

The column 44 is elongate between a bottom end and top end. With general reference to FIGS. 12-20, the column 44 further comprises a slide-off prevention provision 101-104 at, or proximate, the bottom end of the column 44. The slide-off prevention provision 101-104 comprises an enlargement or extension that prevents the vertically-adjustable hitch-ball mounting block 48 from sliding off the bottom end of the column 44. Thus, the vertically-adjustable hitch-ball mounting block 48 has to be slid onto the column 44 over the top end thereof at a time before the drawbar 42.

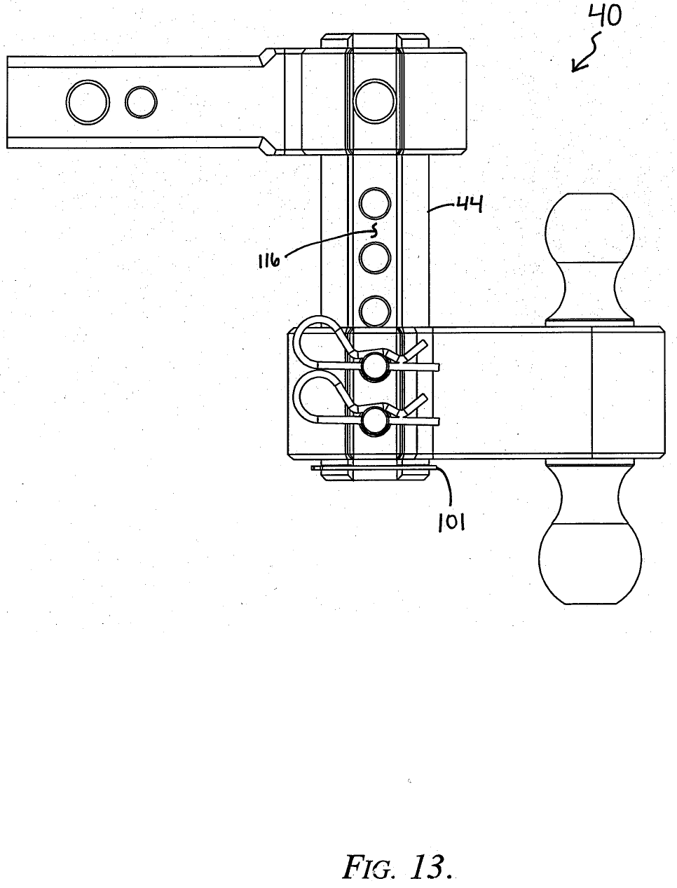

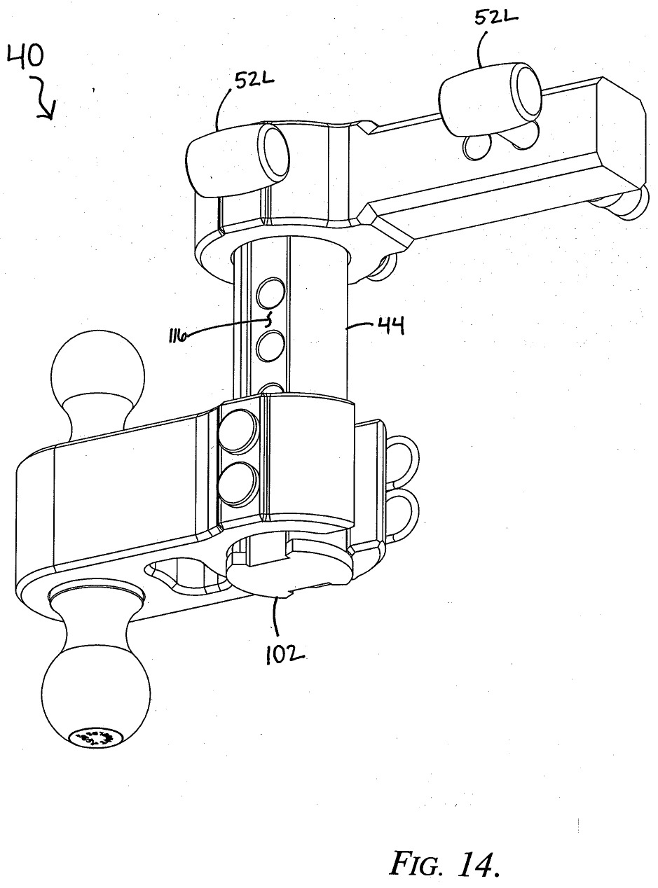

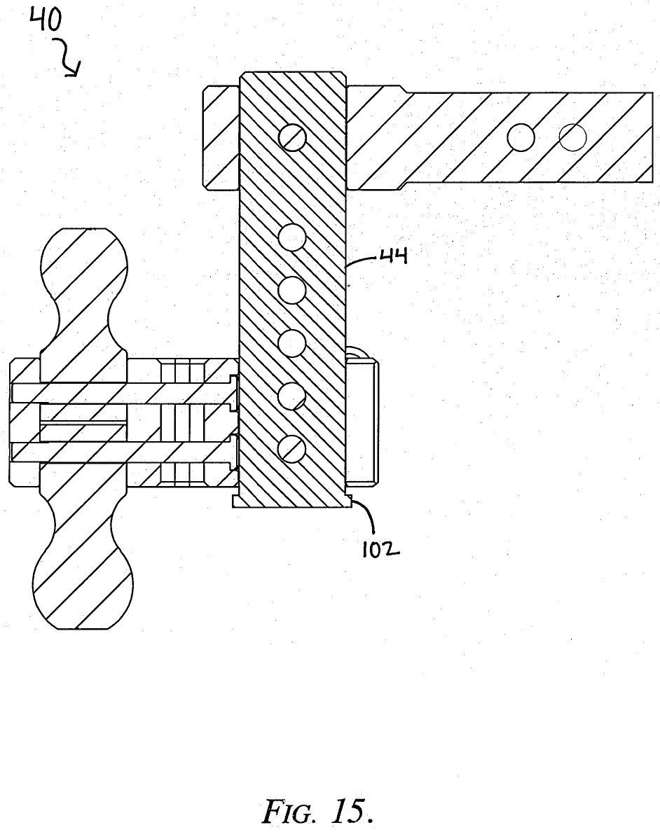

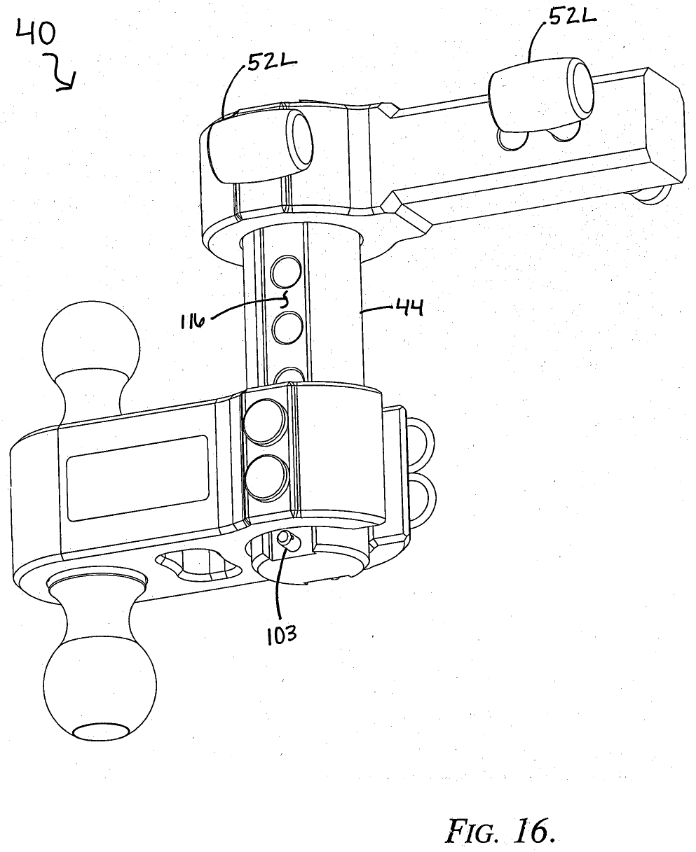

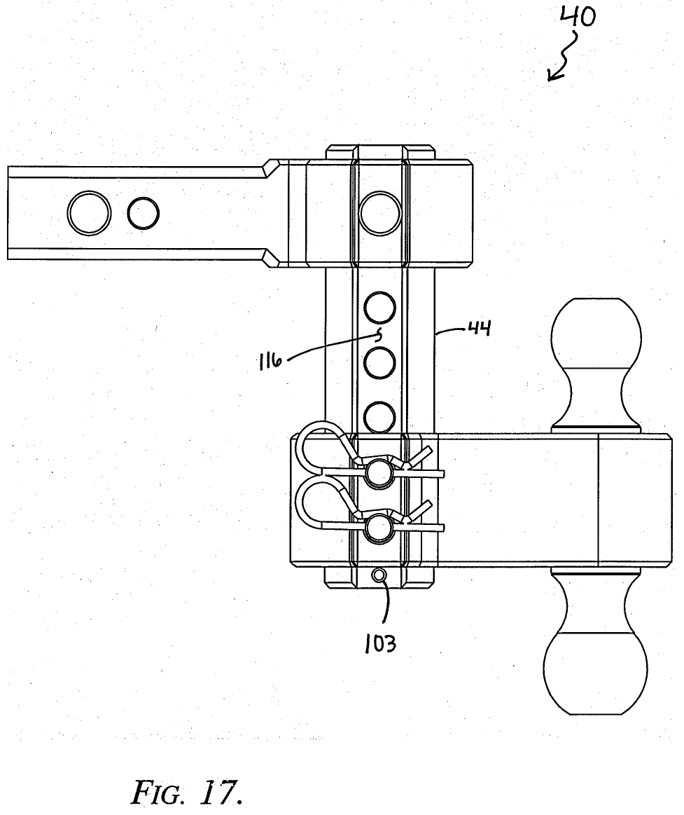

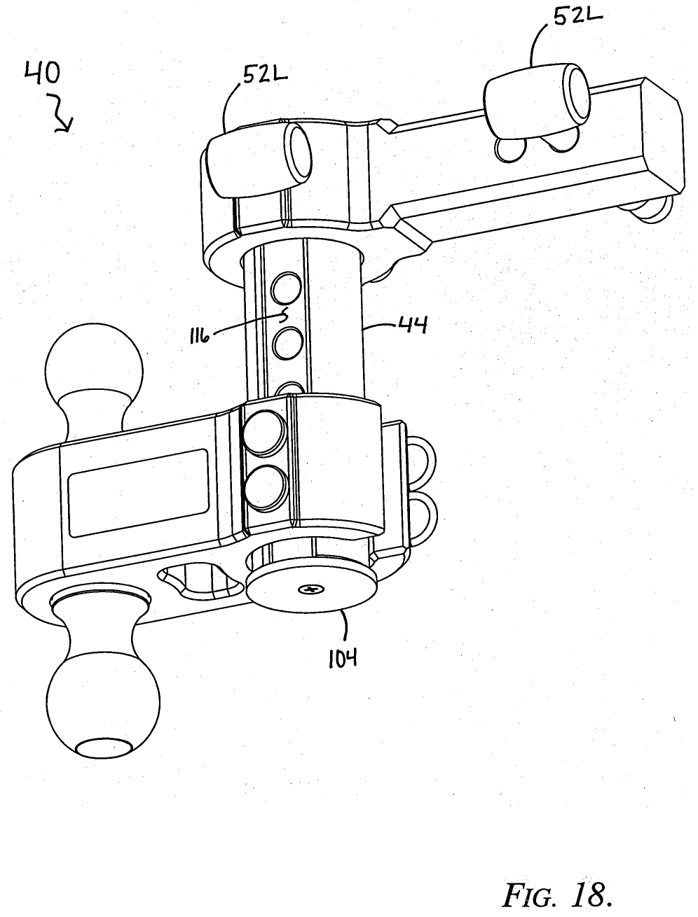

The slide-off prevention 101-104 provision can comprise any of:
a snap ring 101 or external retaining ring 101 (FIGS. 12-13),
an annular flange 102 or an annular series of tabs 102 (FIGS. 14-15),
a weldment (eg., ˜ FIGS. 18-20),
dowel pin 103 or roll pin (FIGS. 16-17),
a fastener (eg., ˜ FIGS. 16-17), or
a fastener and over-sized washer 104 (FIGS. 18-20).

Moreover, the column 44 is preferably formed with one or more axial groove recesses 116 from bottom end to top end. This has been discovered to advantageously reduce sliding friction between the column 44 and the vertically-adjustable hitch-ball mounting block 48 when re-adjusting the elevation of the mounting block 48.

The adjustable hitch assembly 40 would further comprise a plurality of clevis or hitch pins 52. Correspondingly, the drawbar 42, the hitch-ball mounting block 48 and the column 44 are formed with a multiplicity of generally horizontal clevis- or hitch-pin receiving holes 74 for a variety of purposes including releasably connecting:
the drawbar 42 to a receiver tube of a tow vehicle (neither shown),
the drawbar 42 to the column 44, and
the hitch-ball mounting block 48 on the column 44 at variable elevational spacing relative the drawbar 42.

In fact, the column 44 is formed with a whole series of generally-vertically spaced, generally horizontal clevis- or hitch-pin receiving holes 74.

FIGS. 12 and 13 show a second embodiment of an adjustable hitch assembly 40 in accordance with the invention, comprising a snap ring (external retaining ring) retention provision 101 along the bottom of the variable elevation spacing column 44.

FIGS. 14 and 15 show a third embodiment of an adjustable hitch assembly 40 in accordance with the invention, comprising an annular flange retention provision 102 along the bottom of the variable elevation spacing column 44.

FIGS. 16 and 17 show a fourth embodiment of an adjustable hitch assembly 40 in accordance with the invention, comprising a dowel pin (or roll pin) retention provision 103 along the bottom of the variable elevation spacing column 44.

FIGS. 18-20 show a fifth embodiment of an adjustable hitch assembly 40 in accordance with the invention, comprising an over-sized washer retention provision 104 along the bottom of the variable elevation spacing column 44.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. An adjustable hitch assembly, comprising:
a drawbar;
a vertically-adjustable hitch-ball mounting block;
a variable elevation spacing column;
a hitch ball comprising a ball head and a shank base connected by a neck; and
a pin;
wherein the drawbar comprises a generally horizontal drawbar portion having a rectilinear cross-section terminating in an eye-loop portion defining a column-receiving socket for the column to insert therein;
wherein the vertically-adjustable hitch-ball mounting block comprises an eyebar comprising a central bar portion extending between a hitch-ball shank-receiving socket for a hitch-ball shank to insert therein, and, a column-receiving eye-loop end defining a column-receiving aperture for the column to slide therein;
wherein the vertically-adjustable hitch-ball mounting block is vertically adjustable on the variable elevation spacing column; and
one of the bar portion or the column-receiving eye-loop end of the vertically-adjustable hitch-ball mounting block is formed with a pin-receiving hole into the column-receiving aperture and adapted for the pin to secure the hitch ball.

2. The adjustable hitch assembly of claim 1, wherein:
both the bar portion and the column-receiving eye-loop end of the vertically-adjustable hitch-ball mounting block are formed with the pin-receiving hole into the column-receiving aperture that is adapted for a pin to secure a hitch ball; and
the column-receiving eye-loop end of the vertically-adjustable hitch-ball mounting block is formed with an access opening for the flight path of the pin into the pin-receiving hole.

3. The adjustable hitch assembly of claim 2, wherein:
the pin comprises a shank extending between a tip end and an enlarged head; and
the hole through the bar portion of the vertically-adjustable hitch-ball mounting block for the pin defines an entrance in the bar portion, which bar portion is formed so that the entrance of the hole is a shallow enlargement for the enlarged head of the pin to nest therein;
whereby when the column occupies the column-receiving aperture in the vertically-adjustable hitch-ball mounting block, the column impedes removal of the pin, and, the enlarged head of the pin will not impede the vertical adjustability of the vertically-adjustable hitch-ball mounting block on the column.

4. The adjustable hitch assembly of claim 3, wherein:
the shaft of the pin is smooth, whereby not threaded such that insertion and removal of the pin is by sliding not twisting.

5. The adjustable hitch assembly of claim 4, wherein:
the column-receiving eye-loop end of the vertically-adjustable hitch-ball mounting block is formed all the way through with the pin-receiving hole as a through-hole from the entrance in the bar portion to an exit in a far wall of the column-receiving eye-loop end; and
the pin is sized such with the head of the pin nested in the shallow enlargement proximate the entrance, the tip end is proximate to flush with the exit in the far wall of the column-receiving eye-loop end.

6. The adjustable hitch assembly of claim 1, wherein:
the column is cylindrical;
the column-receiving aperture in the vertically-adjustable hitch-ball mounting block is cylindrical; and
the column-receiving socket in the eye-loop portion of the drawbar is cylindrical.

7. The adjustable hitch assembly of claim 6, wherein:
the column is elongate between a base end and top end; and
further comprising a slide-off prevention provision proximate the base end of the column that provides an enlargement or extension that prevents the vertically-adjustable hitch-ball mounting block from sliding off the base end of the column;
whereby the vertically-adjustable hitch-ball mounting block has to be slid onto the column over the top end thereof.

8. The adjustable hitch assembly of claim 7, wherein:
slide-off prevention provision comprises any of:
a snap ring, or external retaining ring,
an annular flange and annular series of tabs,
a weldment,
dowel pin or roll pin,
a fastener, or
a fastener and over-sized washer.

9. The adjustable hitch assembly of claim 1, wherein:
the column is elongate between a base end and top end; and
the column is formed with one or more axial groove recesses from base end to top end whereby reducing sliding friction between the column and the vertically-adjustable hitch-ball mounting block.

10. The adjustable hitch assembly of claim 1, further comprising:
a plurality of clevis or hitch pins;
wherein the drawbar, the hitch-ball mounting block and the column are formed with a multiplicity of generally horizontal clevis- or hitch-pin receiving holes for releasably connecting:
the drawbar to the column, and
the hitch-ball mounting block on the column at variable elevational spacing relative the drawbar.

11. An adjustable hitch assembly, comprising:
a drawbar;
a vertically-adjustable hitch-ball mounting block;
a spacing column;
at least one hitch ball comprising a ball head and a shank base connected by a neck; and
a hitch-ball pin;
wherein the drawbar comprises a generally horizontal drawbar portion having a rectilinear cross-section terminating in an eye-loop portion defining a column-receiving socket for the spacing column to insert therein;
wherein the vertically-adjustable hitch-ball mounting block comprises a central bar portion extending between a hitch-ball shank-receiving socket for a hitch-ball shank to insert therein, and, a column-receiving eye-loop end defining a column-receiving aperture for the column to slide therein;
wherein the vertically-adjustable hitch-ball mounting block is vertically adjustable on the spacing column;
one of the bar portion or the column-receiving eye-loop end of the vertically-adjustable hitch-ball mounting block is formed with a hitch-ball pin-receiving hole into the column-receiving aperture and adapted for the hitch-ball pin to releasably connect the at least one hitch ball; and
a plurality of clevis or hitch pins;
wherein the drawbar, the hitch-ball mounting block and the column are formed with a multiplicity of generally horizontal clevis- or hitch-pin receiving holes for releasably connecting:
the drawbar to the column, and
the hitch-ball mounting block on the spacing column at variable elevational spacing relative the drawbar.

12. The adjustable hitch assembly of claim 11, wherein:
the vertically-adjustable hitch-ball mounting block is produced from slices of extruded aluminum stock and the hitch-ball shank-receiving socket is a through aperture.

13. The adjustable hitch assembly of claim 12, wherein:
the drawbar is produced from slices of extruded aluminum stock and the column-receiving socket is a through aperture.

14. The adjustable hitch assembly of claim 12, further comprising:
another hitch ball comprising a ball head and a shank base connected by a neck; and
another hitch pin;
wherein the shank bases of the one and another hitch balls are each formed with a hitch-ball pin-receiving socket; and
one of the bar portion or the column-receiving eye-loop end of the vertically-adjustable hitch-ball mounting block is formed with another hitch-ball pin-receiving hole into the column-receiving aperture and adapted for the hitch-ball pins to releasably connect the one and another hitch balls relatively inverted relative to each other.

15. The adjustable hitch assembly of claim 11, wherein:
the spacing column is formed with a series of generally-vertically spaced, generally horizontal clevis- or hitch-pin receiving holes and the column-receiving eye-loop end of the vertically-adjustable hitch-ball mounting block is formed with at least one generally horizontal clevis- or hitch-pin receiving hole into the column-receiving aperture.

16. An adjustable hitch assembly, comprising:
a drawbar;
a vertically-adjustable hitch-ball mounting block;
a spacing column;
at least one hitch ball comprising a ball head and a shank base connected by a neck; and
a hitch-ball pin;
wherein the drawbar comprises a generally horizontal drawbar portion having a rectilinear cross-section terminating in an eye-loop portion defining a column-receiving aperture for the spacing column to slidably insert therein;
wherein the vertically-adjustable hitch-ball mounting block comprises a central bar portion extending between a hitch-ball shank-receiving socket for a hitch-ball shank to insert therein, and, a column-receiving eye-loop end defining a column-receiving aperture for the column to slidably insert therethrough;
wherein the vertically-adjustable hitch-ball mounting block is vertically adjustable on the spacing column;
one of the bar portion or the column-receiving eye-loop end of the vertically-adjustable hitch-ball mounting block is formed with a hitch-ball pin-receiving hole into the column-receiving aperture and adapted for the hitch-ball pin to releasably connect the at least one hitch ball; and
wherein the column is elongate between a base end and top end; and
the column further comprises a slide-off prevention provision proximate the base end of the column that provides an enlargement or extension that prevents the vertically-adjustable hitch-ball mounting block from sliding off the base end of the column;
whereby the vertically-adjustable hitch-ball mounting block has to be slid onto the column over the top end thereof at a time before the drawbar.

17. The adjustable hitch assembly of claim 16, wherein:
slide-off prevention provision comprises any of:
a snap ring, or external retaining ring,
an annular flange and annular series of tabs,
a weldment,
dowel pin or roll pin,
a fastener, or
a fastener and over-sized washer.

18. The adjustable hitch assembly of claim 16, wherein:
the column is elongate between a base end and top end; and
the column is formed with one or more axial groove recesses from base end to top end whereby reducing sliding friction between the column and the vertically-adjustable hitch-ball mounting block.

19. The adjustable hitch assembly of claim 16, further comprising:
a plurality of clevis or hitch pins;
wherein the drawbar, the hitch-ball mounting block and the column are formed with a multiplicity of generally horizontal clevis- or hitch-pin receiving holes for releasably connecting:
the drawbar to the column, and
the hitch-ball mounting block on the column at variable elevational spacing relative the drawbar.

20. The adjustable hitch assembly of claim 11, wherein:
the vertically-adjustable hitch-ball mounting block is produced from slices of extruded aluminum stock and the hitch-ball shank-receiving socket is a through aperture; and
the adjustable hitch assembly further comprises:
another hitch ball comprising a ball head and a shank base connected by a neck; and
another hitch pin;
wherein the shank bases of the one and another hitch balls are each formed with a hitch-ball pin-receiving socket; and
one of the bar portion or the column-receiving eye-loop end of the vertically-adjustable hitch-ball mounting block is formed with another hitch-ball pin-receiving hole into the column-receiving aperture and adapted for the hitch-ball pins to releasably connect the one and another hitch balls relatively inverted relative to each other.
